(19) United States
(12) Patent Application Publication
(10) Pub. No.: US 2003/0075676 A1
(43) Pub. Date: Apr. 24, 2003

(54) Apparatus for measuring state of polarization of a lightwave

(76) Inventors: Bernard Ruchet, Charlesbourg (CA); Normand Cyr, Sainte-Foy (CA)

Correspondence Address: ADAMS PATENT & TRADEMARK AGENCY, BOX 11100, STATION H, OTTAWA, ON, K3H 7T8, CA

(21) Appl. No.: 10/278,081

(22) Filed: Oct. 23, 2002

Related U.S. Application Data
(60) Provisional application No. 60/330,547, filed on Oct. 24, 2001.

(51) Int. Cl. G02F 1/01

(52) U.S. Cl. 250/225

(57) ABSTRACT

Apparatus for measuring state of polarization of an input light beam comprises a linear polarizing element (10), e.g. a Glan-Taylor prism, an input fiber and lens (22,24) for directing the input light beam to the linear polarizing element (10), an output stage (26A-26D, 30A-30D, 32A-32D, 34) for receiving the light beam leaving the polarizing element, and at least two waveplates (12A, 12B; 12B, 12C) disposed adjacent each other between the input fiber/lens and the linear polarizing element. Each waveplate has its fast axis oriented at a different predetermined azimuthal angle with respect to the incident light beam. The arrangement is such that first and second portions of the input light beam pass through the linear polarizing element and the two waveplates, respectively, and a third portion of the light beam passes through the linear polarizing element without passing through a waveplate. The output stage determines power levels of the three portions of the light beam, respectively, and derives the state of polarization therefrom.

### TECHNICAL FIELD

This invention relates to apparatus for measuring states of polarization of a lightwave.

### BACKGROUND ART

It is known to determine state of polarization of a light beam by means of Stokes parameters obtained by measuring the total incident power and the power transmitted through three distinct polarization analyzers, whose preferential transmission axes correspond to ê₁, ê₂ and ê₃, i.e., linear-horizontal polarization (the term “horizontal” being used for reference but having no absolute meaning). This has been done by passing the lightwave through a series of optical elements, including linear retarders, and/or rotators and/or polarizers. For example, U.S. Pat. No. 4,681,450 (Azzam) discloses a photopolarimeter in which the light beam is incident in turn upon each of a set of four photodetectors, each having a partially specularly reflecting surface. The surfaces of the photodetectors are each inclined relative to the others such that the output signals from the photodetectors can be used to calculate the Stokes parameters. This is not entirely satisfactory due to alignment problems.

In an article entitled “Corner-cube four-detector photopolarimeter”, Optics & Laser Technology, Vol. 29, No. 5, pp 233-238, 1997, Azzam et al. disclosed how the four photodetectors could be disposed on a corner-cube. Although this might reduce misalignment problems, adhering the photodetectors to the corner-cube could introduce problems due to heating.

U.S. Pat. No. 5,227,623 (Heffner) discloses apparatus for measuring polarization mode dispersion (PMD) in which Stokes parameters are obtained by splitting the light beam into four beams, passing three of the beams through optical elements, measuring the transmitted intensity of each of the four beams, and using the measurements to calculate the Stokes parameters. Not only is this arrangement susceptible to misalignment occurring over a period of time, but also it is susceptible to inaccuracy stemming from the fact that the state of polarization of the fourth beam is not known a priori so compensation of the residual polarization dependency in the fourth detector would be very difficult.

U.S. Pat. No. 5,081,348 (Siddiqui) discloses apparatus for determining the state of polarization of a light beam by expanding the free-space collimated beam and letting the light impinge upon four detectors. Linear polarizing elements serving as analyzers having a relative angle to each other are placed in the optical path in front of two of these detectors. No additional retarding elements are placed in these two paths. However, a retarding waveplate, in combination with a linear polarization element, is placed in front of a third detector. The fourth detector has no polarizing element placed in the optical path and serves to measure the overall intensity. After appropriate calibration, the signals from the first three detectors permit the calculation of the Stokes parameters S1, S2, and S3 to within a constant factor. The signal from the fourth detector permits the determination of Stokes parameter S0, the total power, as well as permitting the normalization of the first three Stokes parameters, and permitting the calculation of the degree of polarization (DOP) of the light beam. This arrangement also suffers from the disadvantage that the state of polarization of the light impinging upon the fourth detector is not known a priori so compensation of the residual polarization dependency in the fourth detector would be very difficult.

The present invention seeks to at least mitigate the problems and disadvantages of such known apparatus for measuring state of polarization.

### DISCLOSURE OF INVENTION

According to the present invention, there is provided apparatus for measuring state of polarization of an input light beam comprising a linear polarizing element, input means for directing the input light beam to the linear polarizing element, output means for receiving the light beam leaving said polarizing element, and at least two waveplates disposed adjacent each other between the input means and the linear polarizing element, each waveplate having its fast axis oriented at a different predetermined azimuthal angle with respect to the incident light beam, the arrangement being such that first and second portions of the input light beam pass through the two waveplates, respectively, and the linear polarizing element and a third portion of the light beam passes through the polarizing element without passing through a waveplate, the output means determining power levels of the three portions of the light beam, respectively, and deriving the state of polarization therefrom.

With such an arrangement, Stokes parameters may be computed to within a common factor. If the actual degree of polarization also is required, a third waveplate, having its fast axis oriented differently from the first two waveplates, may be added, in which case the input means then will direct the input light beam such that another portion of the light beam passes through the third waveplate and the linear polarization element and is received by the output means, the output means deriving the power level thereof and using it in determining the normalized Stokes vectors.

Preferably, all of the waveplates each provide the same degree of retardation.

In preferred embodiments, the waveplates are substantially coplanar.

The waveplates may be arranged as three of four coplanar quadrants of a square corresponding to an input surface of the polarizer. A plate of plain glass or other suitable non-retarding material may comprise the fourth quadrant, and serve to pass the other portion of the light to the output means. Two of the waveplates have their respective fast axes at equal and opposite angles with respect to the polarization axis of the linear polarization element, and the third waveplate has its fast axis at the prescribed angle plus ninety degrees relative to the polarization axis. Advantageously, the waveplates may be square in form, in which case setting of the relative orientations of the three waveplates is relatively simple, involving only lateral inversion of one relative to the other and rotation of the third, through ninety degrees.

Preferably, each waveplate has a retardance of λ/3.

The linear polarization element preferably exhibits a very high extinction ratio, such as that provided by a Glan-Taylor prism.

### BRIEF DESCRIPTION OF THE DRAWINGS

An embodiment of the present invention will now be described, by way of example only, with reference to the accompanying drawings, in which:

FIG. 1 is a perspective schematic representation of an apparatus for measuring state of polarization having three waveplates and a plain glass plate; and

FIG. 2 is a detail end view illustrating respective axes of the three waveplates.

### DETAILED DESCRIPTION OF PREFERRED EMBODIMENTS

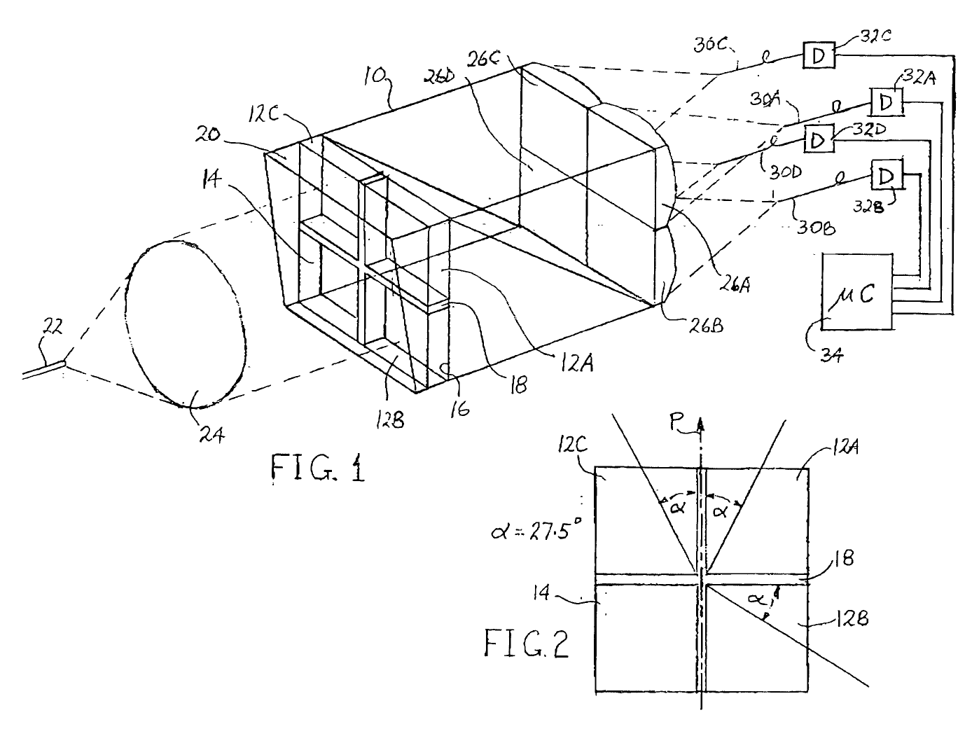

Referring to FIGS. 1 and 2, apparatus for measuring state of polarization of a light beam comprises a parallelepiped linear polarizer 10, specifically a Glan-Taylor prism, having three square waveplates 12A, 12B and 12C each having a retardation of λ/3, i.e., with phase retardation of 2π/3, and a transparent plate (i.e., a window with zero retardation) 14 adhered to its input face 16 using suitable optical cement. The polarizer 10 conveniently is made of calcite and is of an air-gap design, and the plate 14, which has the same thickness as the waveplates 12A-12C, conveniently is made of glass. The waveplates 12A, 12B and 12C and the glass plate 14 comprise quadrants which together cover the input face 16 of the polarizer 10. They are placed into respective openings of a cruciform opaque, divider 18 which has one limb, (shown vertical in FIGS. 1 and 2), aligned in the same sense as the polarizer axis P and attached to adjacent limbs of the divider 18 by adhesive. The cruciform divider 18 “slices” the input light beam cleanly into four portions. A wedge-shaped plate 20 is adhered, using index matching glue, to the front of the waveplates 12A, 12B and 12C and the glass plate 14 and serves to reduce reflections that could lead to undesirable Fabry-Perot-type interferometric noise. Input means comprises a single mode input optical fiber 22 and a collimating lens 24 which collimates light received from the fiber 22 and directs the collimated light beam onto the waveplates 12A, 12B and 12C and the glass plate 14, so that each receives an equal portion of the light beam.

A set of four rectangular, specifically square, lenses 26A, 26B, 26C and 26D adhered to the output face 28 of the linear polarizer 10 receive the corresponding four light components from the waveplates 12A, 12B, 12C and glass plate 14, respectively and focus them into four multimode output optical fibers 30A, 30B, 30C and 30D, respectively, which are coupled to a set of four photodetectors 32A, 32B, 32C and 32D, respectively. The photodetectors 32A, 32B, 32C and 32D convert the optical signals into electrical signals and convey them to a processor 34 which uses their intensities to compute the Stokes parameters.

The three waveplates 12A, 12B and 12C are identical and each has a fast axis at an angle of about 27.5 degrees to one edge. As shown in FIG. 2, however, each of the waveplates 12A, 12B and 12C is disposed with its fast axis at a different angle relative to the polarizer axis P which, in FIG. 2, is shown as extending vertically in the plane of the drawing. Thus, assuming clockwise rotation from the vertical, the fast axes of the waveplates 12A, 12B and 12C are at angles of 27.5 degrees, 117.5 degrees and 332.5 degrees, respectively.

The measured intensity or power of the signal received by way of glass plate 14 and detector 32D represents the degree of polarization and is used with the intensities measured by way of the three waveplates 12A, 12B and 12C and the detectors 32A, 32B and 32C to calculate the Stokes parameters.

It is instructive to consider the operation of the device as if the linear polarizer 10 were in front of the waveplates 12A, 12B and 12C. Thus, the linear polarizer 10 exhibits high transmission for one linear SOP and extinguishes the orthogonal linear SOP (at 180 degrees on the Poincaré sphere). The preferred Glan-Taylor polarizer is recognized as having a high degree of extinction. On leaving the polarizer 10, therefore, the SOP of the light is along the polarizer axis P. Each waveplate rotates the SOP about the sphere, the resultant polarizations corresponding to the equivalent axis of the analyzers.

It should be noted that, in contrast to the technique disclosed by Siddiqui (supra), and other known methods for analysing the SOP of a light beam, all four beams pass through a, preferably common, linear polarizer used as an analyser. Hence, no one light beam permits a direct determination of the Stokes parameter SO. Once the system has been suitably calibrated, the signals from the four detectors permit the determination of the four Stokes parameters.

It should also be noted that optical spectrum analyzers, such as that disclosed by Siddiqui supra, which use analyzers permitting measurement of Stokes parameters S0, S1, S2 and S3, or a linear combination thereof, and having alignments based upon the mathematics used to compute the Stokes vectors, are optimized to square with the first “mathematical solution to the detriment of hardware optimization. Embodiments of the present invention using four polarization analyzers with their axes linearly independent, so that a nonsingular matrix describing the transformation relating the intensities measured at the four detectors to the four Stokes parameters can be constructed, allow more freedom for the hardware to be optimized. While the transformation matrix may be based upon the design, it is preferred to produce it by measurement, i.e., calibration, which gives better precision and reliability. Moreover, the calibration changes little with time or temperature and yet changes smoothly with wavelength, which is desirable.

Thus, the calibration produces, for each wavelength, a calibration transformation matrix that relates the measured intensities to the Stokes vectors. This calibration procedure can be described as follows.

First one generates four known SOPs, each having a DOP of 100%. Each of these states is, in turn, sent to the polarimeter, where one measures the resulting electrical currents.

Generated SOPs:

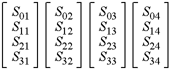

Measured currents:

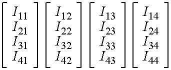

These four SOPs can be grouped into a single 4×4 matrix, and the measured currents grouped into another matrix:

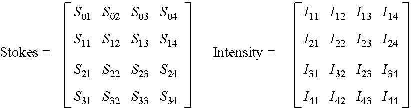

Now, the Stokes matrix is related to the intensity matrix via:

(Stokes)=M_{calibration}·(Intensity)

The Calibration transformation matrix can then be directly calculated via:

M_{calibration}=Stokes·(Intensity)⁻¹

An advantageous and novel feature of the above-described invention is that all four portions of the light beam pass through a common polarizer serving as a linear analyzer element. This allows for a simple and compact design. The only real alignment of the polarizing elements (i.e., waveplates plus polarizer) is very straightforward as the three square waveplates can be “cut” from the same waveplate material, with the fast axis at 27.5 degrees from one edge. The three waveplates are then placed in the appropriate quadrant of the cruciform, whose “vertical” limb is aligned with the polarizer axis P, and setting of the desired orientation of their respective fast axes then involves only “flipping” of one waveplate and rotation of another waveplate through ninety degrees. Of course, there still is alignment via four lenses into the four optical fibers, but this does not involve polarizing elements as such.

An advantage of coupling the four outputs from the lenses 26A, 26B, 26C and 26D by means of the four optical fibers 30A, 30B, 30C and 30D, respectively, is that it eliminates, or at least significantly reduces, inaccuracies which are common in direct detection of a free-space beam by a detector, which can result in changes in the registration between the output beams and their respective detectors. As a general rule, when light is cut by sharp edges of any optical element, there is some diffraction causing the light beam to spread. Because there are four output light beams, any spreading could result in not only a change in registration but also in increased cross-talk. Launching the light beams into optical fibers for conveyance to the detector unit 26 permits better spatial filtering of all but the desired central portion of each light beam, i.e., less affected by edge effects of the waveplates and lenses, which may reduce cross-talk. Although single mode fiber provides excellent spatial filtering becasue of its small core size, launching of the light beams into single mode fibers would be inefficient. Multimode fiber is preferred, therefore, because it provides a good compromise between good spatial filtering and efficient light launching.

It should be appreciated that the invention embraces various alternative configuration and modifications. For example, it is envisaged that the waveplates 12A, 12B and 12C and the glass plate 14 need not be square but could be circular, oval or any other suitable form. However, such a design would be less efficient at collecting the incident light, particularly due to loss of power in the centre of the beam, and would require additional alignment steps in fabrication to ensure that the angles of the fast axes of the waveplates were correctly aligned.

It should also be noted that, if DOP is not required, either, but not both, of the waveplates 12A and 12B could be omitted.

### INDUSTRIAL APPLICABILITY

An advantage of embodiments of the present invention is that they are very compact and robust, particularly as compared with known polarimeters in which the four powers are obtained by splitting the input light beam into four parts sequentially using consecutive or cascaded beamsplitters. Moreover, embodiments of the invention advantageously use only one linear polarizer. Embodiments of the invention find application in various systems, such as that disclosed in copending U.S. patent application No. (Attorney's Docket No. AP883US) filed contemporaneously herewith.

1. Apparatus for measuring state of polarization of an input light beam comprising a linear polarizing element (10), input means (22,24) for directing the input light beam to the linear polarizing element (10), output means (26A-26D, 30A-30D, 32A-32D, 34) for receiving the light beam leaving said polarizing element, and at least two waveplates (12A, 12B; 12B, 12C) disposed adjacent each other between the input means and the linear polarizing element, each waveplate having its fast axis oriented at a different predetermined azimuthal angle with respect to the polarization axis of the polarizer, the arrangement being such that first and second portions of the input light beam pass through the two waveplates, respectively, and the linear polarizing element and a third portion of the light beam passes through the polarizing element without passing through a waveplate, the output means determining power levels of the three portions of the light beam, respectively, and deriving the state of polarization therefrom.

2. Apparatus according to claim 1, further comprising a third waveplate (12C; 12A) disposed adjacent the first and second waveplates, and wherein the input means is disposed to direct the input light beam such that another portion of the light beam passes through the third waveplate and the linear polarization element and is received by the output means, the output means deriving the power level of the third portion and using same in determining the state of polarization.

3. Apparatus according to claim 2, wherein the first, second and third waveplates (12A, 12B, 12C) are arranged as three of four coplanar quadrants of a square corresponding to an input surface of the linear polarizer, a coplanar plate (14) of transparent, non-retarding material comprising the fourth quadrant, two of the waveplates (12A,12C) having their respective fast axes at equal and opposite angles (α) with respect to a polarization axis (P) of the linear polarization element (10), and the third waveplate (12B) having its fast axis at the prescribed angle (α) plus ninety degrees relative to the polarization axis (P).

4. Apparatus according to claim 1, wherein the waveplates each provide the same degree of retardation.

5. Apparatus according to claim 1, further comprising a third waveplate (12C;12A) disposed adjacent the first and second waveplates, and wherein the input means is disposed to direct the input light beam such that another portion of the light beam passes through the third waveplate and the linear polarization element and is received by the output means, the output means deriving the power level of the third portion and using same in determining the state of polarization, and the waveplates each provide the same degree of retardation.

6. Apparatus according to claim 4, wherein each waveplate has a retardance of λ/3.

7. Apparatus according to claim 1, further comprising a third waveplate (12C;12A) disposed adjacent the first and second waveplates, and wherein the input means is disposed to direct the input light beam such that another portion of the light beam passes through the third waveplate and the linear polarization element and is received by the output means, the output means deriving the power level of the third portion and using same in determining the state of polarization, and the first, second and third waveplates (12A, 12B, 12C) are arranged as three of four coplanar quadrants of a square corresponding to an input surface of the linear polarizer, a coplanar plate (14) of transparent, non-retarding material comprising the fourth quadrant, two of the waveplates (12A,12C) having their respective fast axes at equal and opposite angles (α) with respect to a polarization axis (P) of the linear polarization element (10), and the third waveplate (12B) having its fast axis at the prescribed angle (α) plus ninety degrees relative to the polarization axis (P).

8. Apparatus according to claim 7, wherein the waveplates each provide the same degree of retardation.

9. Apparatus according to claim 8, wherein each waveplate has a retardance of λ/3.

10. Apparatus according to claim 1, wherein the waveplates are substantially coplanar.

11. Apparatus according to claim 2, wherein the waveplates are substantially coplanar.

12. Apparatus according to claim 3, wherein the waveplates are substantially coplanar.

13. Apparatus according to claim 4, wherein the waveplates are substantially coplanar.

14. Apparatus according to claim 5, wherein the waveplates are substantially coplanar.

15. Apparatus according to claim 1, wherein the linear polarization element comprises a Glan-Taylor prism.

16. Apparatus according to claim 2, wherein the linear polarization element comprises a Glan-Taylor prism.

17. Apparatus according to claim 3, wherein the linear polarization element comprises a Glan-Taylor prism.

18. Apparatus according to claim 4, wherein the linear polarization element comprises a Glan-Taylor prism.

19. Apparatus according to claim 5, wherein the linear polarization element comprises a Glan-Taylor prism.

20. Apparatus according to claim 6, wherein the linear polarization element comprises a Glan-Taylor prism.
